(19) United States
(12) Patent Application Publication
(10) Pub. No.: US 2013/0030698 A1
(43) Pub. Date: Jan. 31, 2013

(54) APPARATUS AND METHOD OF MAP DIFFERENCE DATA GENERATION

(71) Applicants: Nobutoshi Yamagishi, Obu-city (JP); Hiroyuki Tanaka, Handa-city (JP)

(72) Inventors: Nobutoshi Yamagishi, Obu-city (JP); Hiroyuki Tanaka, Handa-city (JP)

(73) Assignee: DENSO CORPORATION, Kariya-city (JP)

(21) Appl. No.: 13/557,307

(22) Filed: Jul. 25, 2012

(30) Foreign Application Priority Data
Jul. 27, 2011 (JP) 2011-164366

(51) Int. Cl. G01C 21/32

(52) U.S. Cl. 701/452

(57) ABSTRACT

A map difference data delivery apparatus generates map difference data, upon receiving a map update instruction for updating map elements in a map database. To generate the map difference data, the apparatus divides the map elements into multiple groups based on a user preference, such as travel frequency, road attributes, road shape, or road type. The generated map difference data thus includes the map elements exclusively accommodating and matching with the user preference.

### CROSS REFERENCE TO RELATED APPLICATION

The present application is based on and claims the benefit of priority of Japanese Patent Application No. 2011-164366, filed on Jul. 27, 2011, the disclosure of which is incorporated herein by reference.

### TECHNICAL FIELD

The present disclosure generally relates to a data generation method and a data generation apparatus for generating map difference data that accommodates update of map data such as addition, deletion, and modification of map elements and their arrangements.

### BACKGROUND

Conventionally, data of map updates is delivered to a navigation apparatus in a vehicle as map difference data, which is a difference between a pre-update map and a post-update map. That is, when a map update instruction is generated, the map in the navigation apparatus is updated by using such map difference data, updating map elements such as roads, municipal boundaries, and place names. A Japanese Patent No. 4,684,228 (US 2007/0282524 now U.S. Pat. No. 7,688,228) (JP '228) discloses a map update technique in which a map update influence area is identified as a collection of map element updates and all the influences caused by the respective updates, and is used to generate the map difference data. The technique of JP '228 prevents an interruption of a road or the like for the purpose of securely defining a topology of a road network.

However, when the map update influence area is used to generate the map difference data, as disclosed in JP '228, the map difference data of the influence area must sometimes cover a large area. For example, in a case where a long-distance expressway is newly opened, the user of the navigation apparatus may have to pay a very high data communication fee for downloading such data to the navigation apparatus in a vehicle (i.e., taking a very long download/communication time). Further, a portion of such costly data may be used to update unnecessary information of the map, which is not desirable for the user of the navigation apparatus.

### SUMMARY

In an aspect of the present disclosure, a map difference data generation apparatus includes a map data storage for storing map data that represents an arrangement of map elements, a user preference identification unit for identifying a user preference, and a map difference data generation unit for generating map difference data.

The map difference data generation unit receives a map update information, and the map update information provides a map element update. The map element update defines an update of a map element in the map data stored in the map data storage. The map difference data generation unit divides map element updates into multiple groups based on the user preference identified by the user preference identification unit to generate the map difference data.

According to the above-described data generation apparatus, the map element updates in the map update information are divided into user-needs accommodated groups for generating the map difference data, which includes only a part of the map element updates (i.e., which only includes user preference matching updated map elements). Therefore, in comparison to the conventional map difference data generation apparatus for generating the map difference data from a map update influence area in which the map difference data is a collection of map element updates and all the influences caused by the respective updates, the apparatus of the present disclosure reduces the amount of data to be delivered Further, the map difference data includes only the map elements that match with the user preference, thereby reducing the amount of data communication needed for delivering the data to the vehicle without dropping user desired information from the map difference data.

In addition to the above, the map difference data generation apparatus is configured that, when the map update is generated to instruct an update of the map elements, the map difference data generation unit divides map element updates into a plurality of groups by using a criterion of a user travel frequency in a map area defined by the map elements based on the user preference identified by the user preference identification unit.

In such manner, the map elements which are objects of the update are divided into multiple groups, that is, one group of map elements in a relatively-highly frequently traveled area, for example, within the boundary of a prefecture where the user lives, and the other group of map elements in a relatively-less frequently traveled area, for example, beyond the boundary of such prefecture. The map elements in a “high” group (i.e., in the relatively-highly frequently traveled area, or in a highly-frequented area) are turned into the map difference data, for providing the map difference data only for the “high” group. That is, the map difference data may be generated only from the “high” group map elements, thereby (i) prioritizing the “high” group map difference data and (ii) reducing the amount of data communication needed for delivering the data to the vehicle without dropping user desired information from the map difference data.

In addition to the above, the map difference data generation apparatus is configured that the map difference data generation unit divides map element updates into a plurality of groups by using a criterion of an update scope based on the user preference identified by the user preference identification unit.

In such manner, the map elements which are objects of the update are divided into multiple groups, by using a criterion of an update scope such as a major update scope, a minor update scope, or the like, for generating and providing the map difference data for respective groups. The map elements in the “major” update scope group only, or the map elements in the “minor” update scope group only, are used in a prioritized manner to generate one difference data That is, the map difference data may be generated only from the “major” update scope group or only from the “minor” update scope group, thereby (i) prioritizing the map difference data of the “major/minor” update scope group and (ii) reducing the amount of data communication needed for delivering the data to the vehicle without dropping user desired information from the map difference data.

In addition to the above, the map difference data generation apparatus is configured that, when the map update is generated to instruct an update of roads (i.e., the map element update is a road), the map difference data generation unit divides the map element updates into a plurality of groups by using a criterion of road attributes based on the user preference identified by the user preference identification unit.

In such manner, the roads which are an object of the update are divided into two/multiple groups, by using a criterion of road attributes such as a national road, a prefectural road, a city road as well as a road width, a tunnel, a bridge etc., for generating and providing the map difference data for respective groups. Then, the roads in one road attribute group are used to generate one map difference data, and the roads in the other road attribute group are used to generate the other map difference data. That is, the map difference data is generated only from one specific road attribute group or only from the other road attribute group, thereby (i) prioritizing the map difference data of the specific road attribute group and (ii) reducing the amount of data communication needed for delivering the data to the vehicle without dropping user desired information from the map difference data.

In addition to the above, the map difference data generation apparatus is configured that, when the map update is generated to instruct an update of roads, the map difference data generation unit divides map element updates of the roads into a plurality of groups by using a criterion of road shapes based on the user preference identified by the user preference identification unit.

In such manner, the roads which are objects of the update are divided into multiple groups, by using a criterion of road shapes such as a straight road, or a curved road, for generating and providing the map difference data for respective groups. Then, the roads in one road shape update group are used to generate one difference data, and the roads in the other road shape update group are used to generate the other difference data. That is, the map difference data is generated only from one specific road shape group or only from the other road shape group, thereby (i) prioritizing the map difference data of the one specific road shape group and (ii) reducing the amount of data communication needed for delivering the data to the vehicle without dropping user desired information from the map difference data.

In addition to the above, the map difference data generation apparatus is configured that, when the map update is generated to instruct an update of expressways (i.e., the map element update is an expressway), the map difference data generation unit divides the map element updates of expressways into a main road group including main roads of expressways and a ramp road group including roads other than the main roads of expressways based on the user preference identified by the user preference identification unit.

In such manner, the map element updates are divided into two groups, a main road group and other road group. Then, the expressways in the main road group are used to generate one map difference data, and the expressways in the other road group are used to generate the other map difference data. That is, the map difference data is generated only from the main road group or only from the other road group, thereby (i) prioritizing the map difference data of the main road group and (ii) reducing the amount of data communication needed for delivering the data to the vehicle without dropping user desired information from the map difference data.

In addition to the above, the map difference data generation apparatus is configured to include a map difference data delivery unit for delivering, to an in-vehicle apparatus, the map difference data generated by the map difference data generation unit. In such manner, the map difference data is delivered to the in-vehicle apparatus, having the data amount reduced without dropping user desired information from the map difference data.

According to a map difference data generation method of generating map difference data for an update of map data when a map update instruction is generated to update map elements in the map data, the method includes: dividing map element updates of a map update instruction into a plurality of map element data groups based on a user preference; and generating a map difference data of the map element data group.

In such manner, similar to the above, the map elements in the map update are divided into user-needs accommodated groups for generating the map difference data, which includes a part of the updated map elements (e.g., which only includes user preference matching updated map elements). Therefore, in comparison to the conventional map difference data generation method for generating the map difference data from a map update influence area, in which the difference data is a collection of map element updates and all the influences caused by the respective updates, the method of the present disclosure achieves the reduction of the amount of data delivery communication. Further, the map difference data includes only the map elements that match with the user preference, thereby reducing the data amount delivered to the vehicle without dropping user desired information from the map difference data.

### BRIEF DESCRIPTION OF THE DRAWINGS

Other objects, features and advantages of the present disclosure will become more apparent from the following detailed description disposed with reference to the accompanying drawings, in which:

FIG. 1 is a block diagram of a map difference data delivery system of the present disclosure;

FIG. 2 is a flowchart of a process performed by a map difference data delivery apparatus of the map difference data delivery system of the present disclosure;

FIG. 3 is an illustration of a road map specifying road area;

FIG. 4 is an illustration of a road map specifying road attributes;

FIG. 5 is an illustration of a road map specifying road shape; and

FIG. 6 is an illustration of a road map specifying road type.

### DETAILED DESCRIPTION

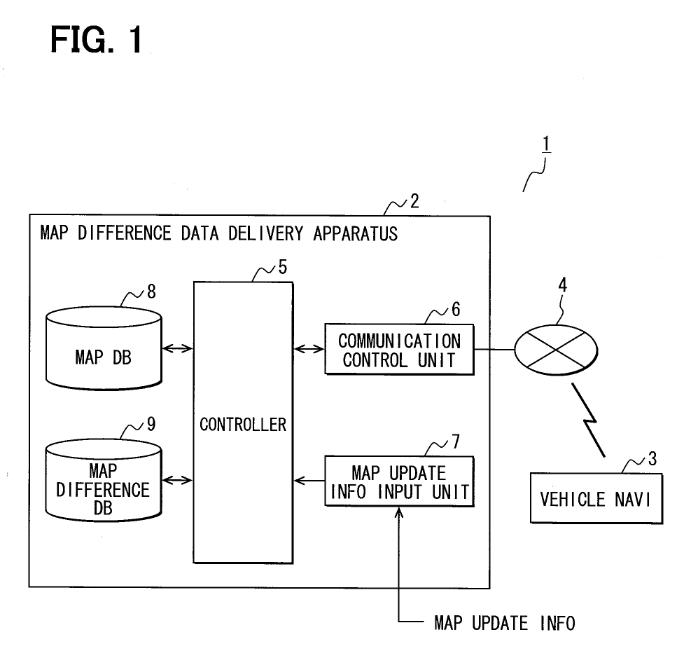

An embodiment of the present disclosure is described in the following with reference to the drawings. FIG. 1 shows a block diagram of a map difference data delivery system 1 that delivers map difference data from a map difference data delivery apparatus 2 to a vehicle navigation apparatus 3. The map difference data delivery system 1 in the present disclosure includes the map difference data delivery apparatus 2 (i.e., a map difference data generation apparatus in claims) for delivering map data to the vehicle navigation apparatus 3 (i.e., an in-vehicle apparatus in claims) that receives the map data. The map difference data delivery apparatus 2 and the vehicle navigation apparatus 3 are communicably coupled with each other through a communication network 4. The communication network 4 includes a stationary communication network and a mobile communication network.

The map difference data delivery apparatus 2 includes a controller 5 (i.e., a user preference identification unit and a map difference data generation unit in claims), a communication control unit 6 (i.e., a map difference data delivery unit in claims), a map update information input unit 7, a map database 8 (i.e., a map data storage in claims), and a map difference database 9.

The controller 5 is a microcomputer of well-known type, having a CPU, a RAM, a ROM, an input/output bus and the like, and controls the operation of the map difference data delivery apparatus 2 such as the data management operation, and the communication operation. The communication control unit 6 controls a wide area communication operation with the communication network 4. The map update information input unit 7 provides a map update information to instruct an addition and a deletion of a map element to/from map data. The map element defined in the map update information is provided as a map element update in the following. The map update information input unit 7 receives the map update information from outside of the map difference data delivery apparatus 2, for example, an input from survey, from satellite imagery or a paper map. In this case, such map update information is generated and provided to the map update information input unit 7 of the map difference data delivery apparatus 2 by an operator using an input device, such as a keyboard and a mouse, when, for example, a new road is opened up, or when an existing road is closed. The map element may be, for example, a road, an intersection, and the like, which serves as a unit of the map.

The map database 8 stores map data representing the arrangement of the map elements. The controller 5 controls the update of the map data in the following manner. That is, when the map update information instructing to add a map element corresponding to, for example, a newly-opened road is provided to the map update information input unit 7, the controller 5 controls the map database 8 to reflect such addition of the map element to the map data in the latest version (i.e., map data having the greatest version number) stored therein. When the map update information instructing to delete a map element corresponding to a closure of a road is input to the map update information input unit 7, the controller 5 controls the map database 8 to reflect such deletion of the map element to the map data in the latest version stored therein. After reflecting the addition/deletion to the map data, the controller 5 assigns the map data a new version number, and stores the new version of the map data in the map database 8.

The vehicle navigation apparatus 3 includes various functions, which are conventionally provided by a navigation apparatus. Such functions include, but are not limited to, a position identification function for identifying a current vehicle position, a read function for reading map data from the storage medium, a map draw function for drawing a map based on the map data read from the storage medium, a destination setting function for setting a destination of travel, a route search function for searching for a route from the current position to the destination, a route draw function for drawing a searched route on the map, and a guidance function for guiding a vehicle according to the searched route (i.e., for providing a route guidance).

When the vehicle navigation apparatus 3 receives the map difference data from the map difference data delivery apparatus 2, the vehicle navigation apparatus 3 updates the map data in the storage medium based on the map difference data received. After such update, the vehicle navigation apparatus 3 may perform various operations, such as map display or route guidance, based on the map data having the newest version.

Further, the vehicle navigation apparatus 3 has a function to transmit, to the map difference data delivery apparatus 2, user preference information that identifies a user's needs or preferences, as well as a user identification (ID) for identifying a user. The user preference information may be, for example, information specified by the user or may be information based on a travel type of the vehicle. The travel type of the vehicle indicates the user's preference of route choice, such as a driver A choosing a wider width road like a detour route, whereas a driver B may choose a straight/short distance route even if the chosen road is narrow and congested. In this case, the user may be an individual user who bought a vehicle, or may be a vehicle manufacturer.

When the controller 5 of the map difference data delivery apparatus 2 receives the user ID and the user preference information transmitted from the vehicle navigation apparatus 3 through the communication control unit 6, the controller 5 stores the user ID and the user preference information in association with each other. The timing of transmission of the user preference information from the vehicle navigation apparatus 3 to the map difference data delivery apparatus 2 may be arbitrarily set, that is, it may be at any time.

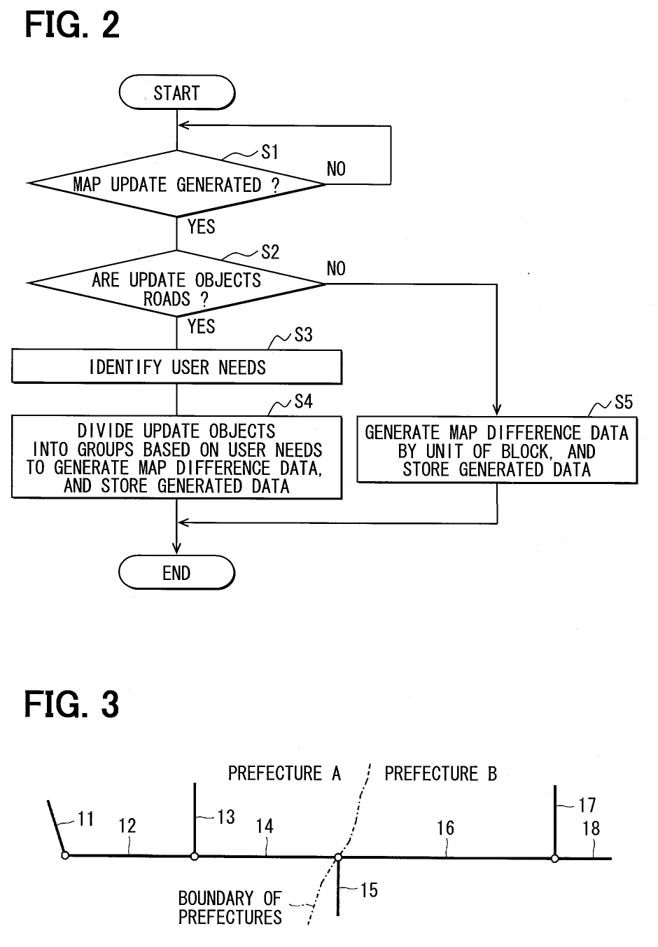

The operation and the advantageous effects of the above configuration of the map difference data delivery system 1 are described with reference to FIG. 2 to FIG. 6.

FIG. 2 shows a flowchart of a process performed by the controller 5 of the map difference data delivery apparatus 2. The controller 5, in S1, determines whether a map update has been generated. In other words, the controller 5 determines whether map update information has been provided to the map update information input unit 7 for updating the map data in the map database 8. If the controller 5 determines that map update information has been provided to the map update information input unit 7 by, for example, the operation of an input device, the controller 5 determines that the map update has been generated (S1, YES).

The controller 5, in S2, determines whether a map element update of the map update information is a road (S2). If the controller 5 determines that the map element update of the map update information is a road (S2, YES), it, in S3, identifies a user's needs based on the user preference information stored in the map difference data delivery apparatus 2. Based on the user preference information, the controller 5 divides the map element updates provided in the map update information into multiple groups for generating the map difference data, and stores the map difference data generated in the map difference database 9 (S4). In other words, the controller 5 stores, for each of the user IDs, the map difference data based on the identified needs of the user.

More practically, when the map element updates are in a preset map area, the controller 5 divides the map element updates into two groups: a first group of map elements are provided in a highly-frequented area where the user travels frequently (e.g., an area of a certain prefecture) and a second group of map elements are provided in a less-frequented area where the user travels less frequently (e.g., an area out of a boundary of the certain prefecture). Accordingly, the map elements in the highly-frequented area are used to generate the map difference data.

For instance, as shown in FIG. 3, when roads 11 to 14 and roads 15 to 18 are in respectively different prefectures or municipalities, the travel frequency of a user in those areas are respectively determined based on, for example, the travel history of the user. Therefore, if the travel frequency of the user is greater in a prefecture A than in a prefecture B (i.e., when the user preference for prefecture A is higher than prefecture B), the map difference data is generated in a prioritized manner for the roads 11 to 14 that belong to prefecture A, instead of providing map difference data for all the roads 11 to 18 that belong to prefecture A and B. The map difference data generated is then stored in the map difference database 9 in association with the user ID.

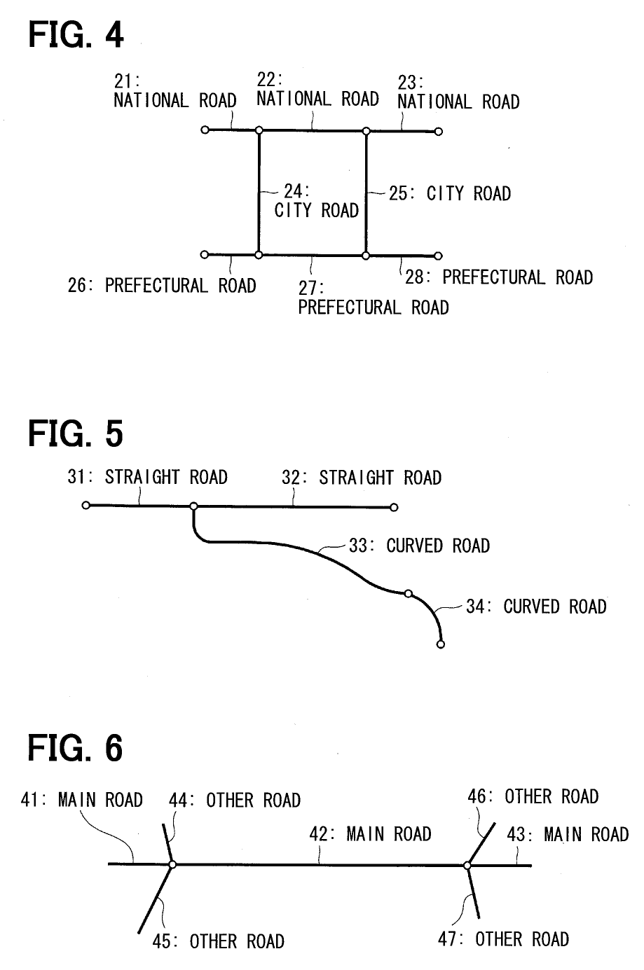

Further, when the map element updates are roads, the controller 5 may divide the roads into groups by using a criterion of the road attributes. For example, road attributes such as a national road, a prefectural road, a city road as well as a road width, a tunnel, a bridge, may be used as criteria for grouping the map element updates, and grouped roads are used to generate the map difference data. For instance, with reference to FIG. 4, roads 21 to 23 are the national roads, roads 24, 25 are the city roads, and roads 26 to 28 are the prefectural roads. Based on the travel history of the user, if the user travels more frequently on national roads than other roads (i.e., the user preference for the national road is higher than the other road categories), the map difference data is generated for the national roads 21 to 23 only in a prioritized manner, and not for all of the roads 21 to 28. Accordingly, the map difference data generated of the national roads is stored in the map difference database 9 in association with the user ID.

Further, when the map element updates are roads, the controller 5 may divide the roads into groups by using a criterion of the shape of the roads such as a straight road, a curved road and the like, for generating the map difference data. For instance, with reference to FIG. 5, roads 31, 32 are straight roads and roads 33, 34 are curved roads. Based on, for example, the travel history of the user, if the user travels more frequently on a straight road than other roads (i.e., the user preference for the straight road are higher than the curved road), the map difference data is generated for only the straight roads 31, 32 in a prioritized manner, and is not generated for all of the roads 31 to 34, which include the curved roads. Accordingly, the map difference data generated for the straight roads 31, 32 is stored in the map difference database 9 in association with the user ID.

Further, when the map element updates are expressways, the controller 5 may divide the expressways into groups by using a criterion of the road types, such as main roads and other roads (i.e., ramp) in the expressway, for generating the map difference data. For instance, with reference to FIG. 6, roads 41 to 43 are main roads and roads 44 to 47 are ramp roads used for access to the main road 41 to 43. The map difference data is generated for the main roads 41 to 43 in a prioritized manner, and is not generated for all of the roads 41 to 47, which includes the other roads 44-47. The map different data generated for the main roads of the expressway is stored in the map difference database 9 in association with the user ID.

Thereafter, the user of the vehicle navigation apparatus 3 may perform an operation for requesting the map difference data via the vehicle navigation apparatus 3. When the user requests the map different data, the communication control unit 6 receives, from the vehicle navigation apparatus 3, a map difference data request signal that includes the request for such data, and the controller 5 identifies the user ID in such signal. The controller 5 then reads the map difference data that is stored in association with the user ID identified from the map difference database 9, and transmits the map difference data from the communication control unit 6 to the vehicle navigation apparatus 3.

With continuing reference to FIG. 2, when the controller 5 determines that the map element updates are not roads (e.g., the map element updates may be a background, a place name, or a map mark) (S2, NO), the controller 5 generates the map difference data for a unit of blocks in the map, and stores the map difference data generated in the map difference database 9 (S5).

In the above description, the map element updates are roads. However, the map element updates may be, for example, intersections, and the intersections may be grouped in a similar manner. That is, according to the attributes of the intersection, such as a traffic signal equipped intersection, a signal-less intersection, a right-turn arrow signal intersection, a no right-turn signal intersection and the like, the intersections may be divided into multiple groups, for the generation of the map difference data.

Further, the user may set the road attributes and/or the road shapes for the grouping of map element updates by, for example, using the vehicle navigation apparatus 3, and such user setting of the grouping of the map element updates may be transmitted from the vehicle navigation apparatus 3 to the map difference data generation apparatus 2, for the generation of the map difference data in the map difference data generation apparatus 2.

Further, the map element updates may be divided into multiple groups based on a grouping criterion of map update scope. For instance, the map element updates may be divided into a major update scope group in which the map elements are grouped in terms of degree or rank of a road. For example, a major update scope group may include a high-rank road, such as an inter-state highway or national road, and a minor update scope group may include low-rank road, such as a local road or a road in a city/village. That is, the map difference data may be generated only from the “major” update scope group or may be generated only from the “minor” update scope group.

In the present embodiment, a map update information for updating a map is generated for instructing the update of map elements of the map data stored in the map database 8. Based on the user preference, the map element updates for the map data are grouped into multiple groups to generate the map difference data for respective groups, where the map difference data for only the map element updates that match with the user preference are generated, instead of generating the map difference data for all of the map element updates provided in the map update information. Therefore, the amount of data delivered to the vehicle navigation apparatus 3 is reduced without relinquishing the user's desired information from the map difference data.

As way of example, when the highly-frequented areas where the user has frequently traveled are grouped to generate the map difference data, the highly-frequented areas are provided as the map difference data for the user. Additionally, the roads in the map data may be grouped according to the road attributes (i.e., a national road, a prefectural road, a city road as well as a road width, a tunnel, a bridge etc.) to generate the map difference data, the map difference data can be generated and provided for the user, for each of the multiple groups according to the road attributes.

Further, when the roads in the map data are grouped according to the road shapes (i.e., a straight road, a curved road, etc.) to generate the map difference data, the map difference data can be generated and provided for the user, for the multiple groups according to the road shapes.

Furthermore, when the expressways in the map data are grouped according to the road types (i.e., a main road, a ramp road, etc.) to generate the map difference data, the map difference data can be generated and provided for the user, for the multiple groups (i.e., for one group including the main roads and the other group including the ramp roads) according to the road types.

Although the present disclosure has been fully described in connection with the preferred embodiment thereof with reference to the accompanying drawings, it is to be noted that various changes and modifications will become apparent to those skilled in the art.

For example, the delivery time of the map difference data from the map difference data delivery apparatus 2 to the vehicle navigation apparatus 3 may be arbitrarily set, that is, may be at any timing. That is, the data delivery may be triggered by the user operation as described above, or may be triggered at a regular interval such as at every 30 days or the like, or may be triggered at a regular travel distance based on the management of the travel distance of the vehicle.

Such changes and modifications are to be understood as being within the scope of the present disclosure as defined by the appended claims.

What is claimed is:

1. A map difference data generation apparatus comprising:
a map data storage for storing map data that represents an arrangement of map elements;
a user preference identification unit for identifying a user preference; and
a map difference data generation unit for generating map difference data by dividing map element updates into a plurality of groups based on the user preference identified by the user preference identification unit upon receiving a map update information, wherein a map element update is provided in the map update information for instructing an update of a map element in the map data stored in the map data storage.

2. The map difference data generation apparatus of claim 1, wherein
when the map update information is generated to provide map element updates for instructing an update of the map elements,
the map difference data generation unit divides map element updates into a plurality of groups by using a criterion of a user travel frequency of a map area defined by map elements based on the user preference identified by the user preference identification unit.

3. The map difference data generation apparatus of claim 1, wherein
when the map update information is generated to provide map element updates for instructing an update of the map elements,
the map difference data generation unit divides map element updates into a plurality of groups by using a criterion of a map update scope based on the user preference identified by the user preference identification unit.

4. The map difference data generation apparatus of claim 1, wherein
when the map update information is generated to provide map element updates for instructing an update of map elements and the map elements being roads,
the map difference data generation unit divides map element updates into a plurality of groups by using a criterion of road attributes based on the user preference identified by the user preference identification unit.

5. The map difference data generation apparatus of claim 1, wherein
when the map update information is generated to provide map element updates for instructing an update of map elements and the map elements being roads,
the map difference data generation unit divides map element updates into a plurality of groups by using a criterion of road shapes based on the user preference identified by the user preference identification unit.

6. The map difference data generation apparatus of claim 1, wherein
when the map update information is generated to provide map element updates for instructing an update of map elements and the map elements expressways,
the map difference data generation unit divides map element updates into a main road group including main roads of expressways and a ramp road group including roads other than the main roads of expressways based on the user preference identified by the user preference identification unit.

7. The map difference data generation apparatus of claim 1, further comprising:
a map difference data delivery unit for delivering, to an in-vehicle apparatus, the map difference data generated by the map difference data generation unit.

8. A map difference data generation method of generating map difference data for an update of map data when a map update instruction is generated and provides map element updates for updating map elements in the map data, the method comprising:
dividing map element updates of a map update instruction into a plurality of map element data groups based on a user preference; and
generating a map difference data of the map element data group.
